(19) United States
(12) Patent Application Publication
(10) Pub. No.: US 2009/0289110 A1
(43) Pub. Date: Nov. 26, 2009

(54) Wireless Biometric Computer Mouse with Integrated Credit Card Reader

(76) Inventors: Paul Regen, Felton, CA (US); Peter Garrett, Aptos, CA (US)

Correspondence Address: CENTRAL COAST PATENT AGENCY, INC, 3 HANGAR WAY SUITE D, WATSONVILLE, CA, 95076, US

(21) Appl. No.: 12/470,582

(22) Filed: May 22, 2009

Related U.S. Application Data
(60) Provisional application No. 61/055,308, filed on May 22, 2008.

(51) Int. Cl. G06F 17/00; G06F 3/033

(52) U.S. Cl. 235/380; 345/163

(57) ABSTRACT

Accordingly, in an embodiment of the invention, a computer mouse is provided and includes a digital medium for storing executable software and user data, a wireless transceiver, a credit card reader, and a biometric scanner. A user operating the mouse connected to a computing appliance may validate stored credit card information as belonging to the user by performing a biometric match of biometrics of the user taken by the biometric scanner against biometrics and profile data stored in a network-based data server, and whereupon a successful match of biometrics invokes a graphics user interface stored on the digital medium to display on a display device accessible to the computing appliance, the interface containing the credit card information belonging to the authenticated user for the one or more cards authenticated.

### CROSS-REFERENCE TO RELATED DOCUMENTS

The present invention claims priority to a U.S. provisional patent application Ser. No. 61/055,308, filed on May 22, 2008, entitled “Wireless Biometric Computer Mouse with Integrated Credit Card Reader” disclosure of which is incorporated herein in its entirety by reference.

### BACKGROUND OF THE INVENTION

1. Field of the Invention

The current invention is generally in the technical area of computer peripheral devices, and relates more particularly to input devices like pointing devices for entering the input data. This invention more particularly relates to a computer device commonly known as a mouse and integrated with biometric data scanners and credit card readers and the like.

2. Discussion of the State of the Art

An input device in the computing industry is generally a computer hardware device used to provide data and control signals to an information-processing device. Typical examples of input devices include keyboard and mouse. The pointing devices are the input devices that are used to specify a position in space. A mouse is a very common pointing device. The mouse is a small handheld device, which is moved over a horizontal surface to generate data to a computer to move a cursor in the display screen in the computer. Generally a mouse includes a small case provided with one or more buttons. In some cases, a mouse is also provided with a wheel to enable the user to carry out various system-dependent operations. The mouses are classified into mechanical mouses and optical mouses.

The first mechanical mouse used in 1970 has two gear wheels that are arranged perpendicular to each other. The rotation of each wheel is transformed into a motion along one axis. The ball type mechanical mouse developed in 1972 has two rollers rolling against the two sides of a single ball that is provided to replace the external wheels. The ball may rotate in any direction. The two rollers are rotated to interrupt optical beams to generate electrical signals that are used to move a pointer in a display screen in the computer. The modern computer mechanical mouse comprises a hard rubber mouse ball and three buttons. Another type of mechanical mouse called analogue mouse uses potentiometers rather than encoder wheels to generate electrical signals. An opto-mechanical mouse is provided with a ball or crossed wheels to detect the rotation of the shaft using an optical encoder with lower friction and improved performance.

An optical mouse is provided with a light-emitting diode and photodiodes to detect the movement of the mouse with respect to the underlying surface. The early optical mouse is developed in two different types. One type of optical mouse is formed with an infrared LED and a four quadrant infrared sensor while the second type of optical sensor is formed with a chip including a light image sensor and a motion detection sensor. A modern surface independent optical mouse is provided with an optoelectronic sensor to collect successive pictures of the surface and an image-processing chip. The optical mouse illuminates the surface underneath with a LED or a laser diode. The changes between the successive image frames are detected using an image-processing chip. The detected changes in the frames are translated into a movement along the two axes to move a cursor on the display screen. The mouses are connected to the computer through wired cable or through wireless protocol to transmit the input data to the computers.

With the advent of e-commerce, on-line shopping or shopping through the Internet has become a major aspect of retail sales. In order to carryout online shopping through the Internet, consumers have to enter their credit card numbers, along with the other pertinent information on their credit cards, such as, for example their name, the expiration date of the credit card, and the three digit security code on the back of their credit card. For consumers who shop regularly through the Internet, the websites of most retailers will offer a facility to enable the consumer/customer to save their personal credit card information within the specified fields so that the consumers may expedite their shopping and checkout experience in the subsequent shopping operations through that specific retailers' website. In several instances, they must also add their home address, telephone number, etc.

However, identity data theft perpetrated by computer hackers has increased dramatically. As a result, many consumers are reluctant to store their personal credit card information within specific Retailers' websites, for fear of the information being stolen. This presents a serious problem for consumers who shop for goods regularly through the Internet, as they have to re-enter all of their personal credit card information along with their home address, telephone number, etc., during every shopping instance.

Yet another problem for consumers purchasing through the Internet is to manage/check their credit card balances in real-time while shopping to avoid purchase value being exceeded over the credit card limit value. A facility to manage/check their balance in real-time would also help consumers to save time in their shopping experience, because the consumers are able to monitor and adjust the purchased value of goods to be within their available credit value limit, thereby avoiding rejection of purchased goods. Moreover, using a password or biometric data can ensure security of the stored data. The use of biometric data provides a foolproof way of saving personal data or stored data as the biometric could not be easily copied.

Hence there is a need for a system to enable consumers to enter and save personal data quickly, easily and safely during purchases using credit cards. Also there is a need to develop an input device integrated with a data security function and a credit card reading function.

### SUMMARY OF THE INVENTION

A problem stated above is that when shopping on line it is desirable to be able to quickly and easily submit credit information and to validate the amount of credit available while making a purchase, but current methods for taking credit card information during an online shopping session require the user to type in the data and provide no way of determining credit available before submitting the credit data to the shopping interface.

The inventors therefore searched input device technology and network-based shopping methods looking for elements that exhibit integrative qualities that could be harnessed to provide a secure way to submit and validate credit card information before engaging a purchase form on a shopping page. Every network-based shopping site is driven by the need to accept digital information in the way of credit card data and user information, frequent byproducts thereof being credit card theft, compromised security, and misuse of credit information.

Online shopping sites are accessible to consumers through network-connected computing appliances and network connections, graphics interfaces, data servers, credit card readers, and authentication services are typically part of such apparatus.

The inventors realized during an inventive moment that if a computing input device such as a computer mouse could be used as a system for authenticating user credit card data before it is submitted to an online shopping site, greater efficiency and better security might result. The inventors therefore constructed a system for inputting and authenticating credit card data that enabled users to authenticate data, review credit information including available balance, and populate Web forms without manually typing the credit card data and user information.

Accordingly, in an embodiment of the invention, a computer mouse is provided and includes a digital medium for storing executable software and user data, a wireless transceiver, a credit card reader, and a biometric scanner. A user operating the mouse connected to a computing appliance may validate stored credit card information as belonging to the user by performing a biometric match of biometrics of the user taken by the biometric scanner against biometrics and profile data stored in a network-based data server, and whereupon a successful match of biometrics invokes a graphics user interface stored on the digital medium to display on a display device accessible to the computing appliance, the interface containing the credit card information belonging to the authenticated user for the one or more cards authenticated.

In one embodiment the digital medium is an onboard memory chip. In one embodiment the graphics user interface has network connectivity to the network-based data server via a universal resource locator. In one embodiment the credit card reader has a card insert bay. In another embodiment the credit card reader has a card-swiping slot. In one embodiment the computer mouse further includes one or more visual indicators of a successful read by the card reader. In a variation of this embodiment the computer mouse further includes one or more visual indicators of a successful read of biometrics.

In one embodiment the network-based data server is hosted by a credit card company issuing the credit card or cards owned by the user. In another embodiment the network-based data server is hosted by a third-party service organization that services multiple credit card companies and financial institutions. In one embodiment the biometrics scanner scans thumb or finger prints. In another embodiment the biometrics scanner scans the user's eye. In one embodiment the digital medium holds credit card information for multiple users that have authorization to use the mouse as a card reader.

According to another aspect of the present invention, a method is provided for authenticating credit card data for use in a network-hosted shopping interface. The method includes the steps (a) reading the credit card data using a credit card reader in communication with a network-connected computing appliance, (b) scanning a biometric of the credit card owner using a biometrics scanner in communication with the network-connected computing appliance, (c) transmitting the credit card data and the scanned biometric along with a graphics user interface or a command to execute a graphics user interface to the network-connected computing device, (d) executing a universal resource locator from the graphics user interface, the universal resource locator addressing an authentication service hosted on a network-connected data server, (e) sending the credit card data and scanned biometric to the authentication service, (f) performing a lookup in a data repository via the authentication service to attempt to match the credit card data and biometric to data held in the repository, and (g) upon finding a match, sending all relevant credit card data and information back to the graphics user interface.

In one aspect of the method in step (a) the credit card reader is integrated with a computer mouse. In this aspect in step (b) the biometrics scanner is integrated with the computer mouse and credit card reader. In a variation of this aspect in step (a) the credit card data is read by inserting a credit card into a card bay of the credit card reader. In this aspect in step (b) the biometric scanner scans a fingerprint or a thumbprint. In another aspect variation in step (c) the method of transmission is wireless data transfer.

In one aspect of the method in step (d) execution of the universal resource locator is automated and occurs as part of executing the graphics user interface. In this aspect in step (g) the information sent back includes additional credit card data validated by the same biometric match.

In one aspect the method further includes a step (h) for selecting a credit card data set returned to the graphics user interface in step (g) for use in an online shopping interface displayed on the network-connected computing appliance. In a variation of this aspect the method further includes a step (i) for populating a Web form with the credit card data and information selected in step (h).

### BRIEF DESCRIPTION OF THE DRAWING FIGURES

FIG. 1 is a top perspective view of a wireless biometric computer mouse with an integrated card reader according to one embodiment of the present invention.

FIG. 2 is a top perspective view of the wireless biometric computer mouse of FIG. 1, in which a credit card is being inserted into the card reader, according to one embodiment of the present invention.

FIG. 3 is a top perspective view of the wireless biometric computer mouse of FIG. 1, in which the credit card is inserted fully into the card reader, according to one embodiment of the present invention.

FIG. 4 is a top perspective view of the wireless biometric computer mouse with of FIG. 1, in which a biometric scanner button is illuminated to indicate completion of the biometric scanning process, according to one embodiment of the present invention.

FIG. 5 is a front view of a computer screen and an enlarged view of a graphical user interface after insertion of a credit card and completion of biometric scanning in the wireless biometric computer mouse of FIG. 1, according to one embodiment of the present invention.

FIG. 6 is a top perspective view of a wireless biometric computer mouse with an integrated card reader having a card swipe interface according to one embodiment of the present invention.

FIG. 7 is a top perspective view of the wireless biometric computer mouse of FIG. 6, in which a credit card is being swiped, according to one embodiment of the present invention.

FIG. 8 is a block diagram illustrating basic circuitry components 800 of mouse 100 of FIG. 1 according to an embodiment of the present invention.

FIG. 9 is an architectural overview of a credit authentication network 900 incorporating mouse 100 of FIG. 1 according to an embodiment of the present invention.

### DETAILED DESCRIPTION

The inventors provide a data input system that can be used to read credit card data authenticate the data to a user and facilitate form filling of the credit card data into a Web form without manual typing. The invention is described in enabling detail in examples presented below, which may represent more than one embodiment of the invention.

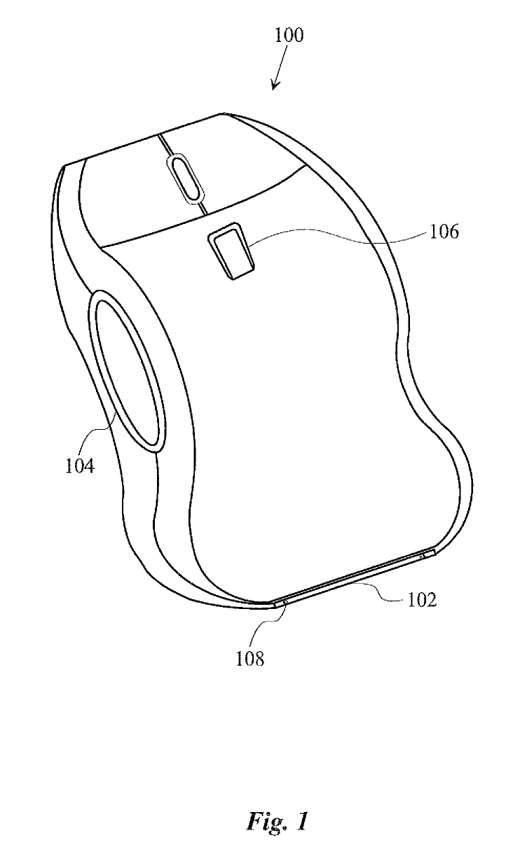

FIG. 1 is a top perspective view of a wireless biometric computer mouse 100 with an integrated card reader according to one embodiment of the present invention. As shown in FIG. 1, wireless biometric computer mouse 100 is provided with a credit card reader having a card insert slot 102 strategically located at the base of mouse 100 to receive a credit card. Mouse 100 is wireless and communicates with a host computing appliance using a wireless protocol, however wireless communication between mouse 100 and a computing appliance should not be viewed as a limitation of the present invention. Mouse 100 may communicate with a host using a universal serial bus (USB), a serial port and cable or some other cabled connection.

Mouse 100 may be an optical mouse or a mechanical mouse without departing from the spirit and scope of the present invention. Mouse 100 in this embodiment has light emitting diodes (LEDs) 108 provided at opposite ends of card insertion slot 102 to indicate status of the card reading process. LED 108 will emit red light indicating to a user that a credit card is not yet engaged fully with an internal credit card reader, and the card is not read completely. When a credit card is inserted into card reader slot 102 fully, LED 108 will emit green light to indicate to the user that the credit card is fully engaged with the internal credit card reader. In another embodiment described further below the internal credit card reader in mouse 100 has a card-swiping slot adapted to enable a credit card to be swiped instead of inserted.

In this example, a biometric scanner interface 104 is provided at a side surface of wireless mouse 100. Scanner button 104 may be pressed by a user to activate a fingerprint or a thumbprint scanning process. In one embodiment, a light located around the perimeter of biometric finger print button 104 illuminates to indicate to the user that the thumbprint or the fingerprint of the user is scanned successfully when a thumbprint or finger print of a user is read fully. In another embodiment LEDs may be provided in a similar fashion as for the card slot with a red light illuminating before a thumbprint is fully scanned and a green light illuminating upon a successful scan of a thumb or fingerprint.

In one embodiment a quick-load button 106 is provided on the upper surface of the wireless mouse. Quick-load button 106 is adapted to enable a user to load data into a Web form without requiring the user to manually type the data into the Web form. For example, when the button is pressed while navigating a Web form a computing appliance hosting the biometric mouse will quickly populate specific data fields of the form with credit card data and personal information like user's name, expiration date of the credit card, the three digit security code provided on the back of credit card, the user's home address, telephone number, and so on. This feature is utilized during an online shopping session such as at a virtual checkout page of an online store.

A graphics user interface (GUI) may be provided to mouse 100 and may be embedded on or otherwise stored in an on-board memory of mouse 100. A GUI is not illustrated in this example but is described latter in this specification. Such a GUI is adapted to list a user's credit card information and associated information like issuing bank, available credit balance, recent charge history, and so on. In one embodiment the GUI executes on the mouse and displays on the host computing appliance once a credit card is read and a thumbprint scan is taken. In one embodiment the GUI is resident on the host computing appliance and a command to execute the GUI is provided in the onboard memory of the mouse. In this case the mouse sends the execution command as input to the computer, which then executes and displays the interface.

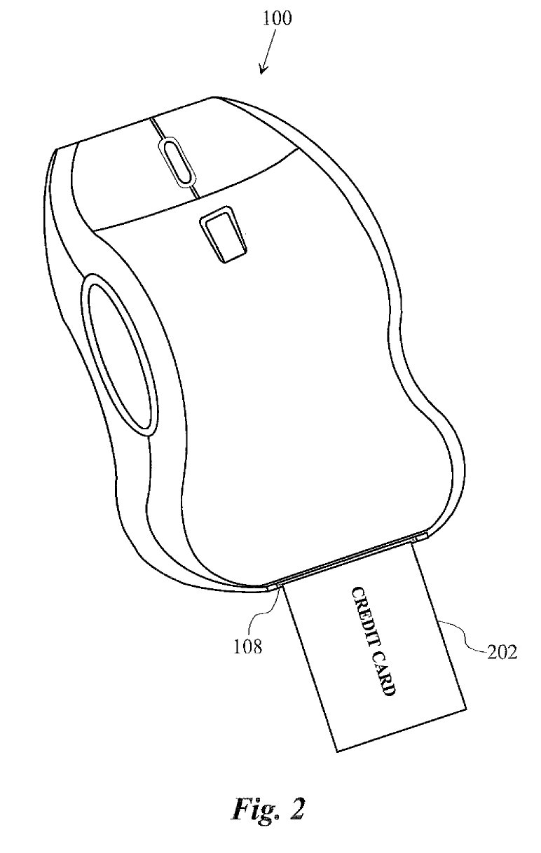

FIG. 2 is a top perspective view of computer mouse 100 of FIG. 1, in which a credit card is being inserted into the card reader, according to one embodiment of the present invention. As shown in this example a credit card 202 is inserted into credit card reader slot 102 provided at the base of wireless mouse 100. LEDs 108 provided at the sides of credit card reader slot 102 turn red to indicate to the user that credit card 202 is not yet fully engaged with the internal credit card reader. In other embodiment the LEDs may glow another color or may be provided at alternative locations on mouse 100 without departing from the spirit and scope of the present invention. Although not illustrated in this example, mouse 100 may further include a pin-pad for inputting a pin number associated with a debit card that may also be used as a credit card.

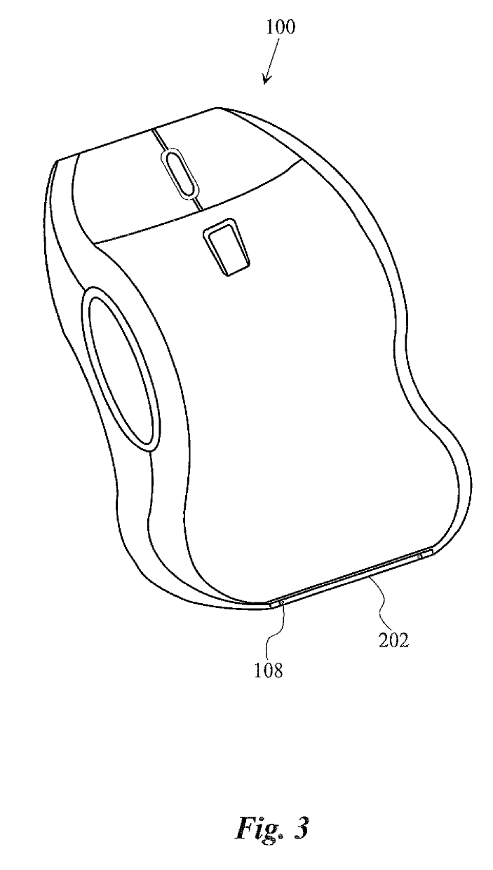

FIG. 3 is a top perspective view of computer mouse 100 of FIG. 1, in which the credit card is inserted fully into the card reader, according to one embodiment of the present invention. As shown in FIG. 3, LED 108 provided at the sides of credit card reader slot 102 turns green to indicate to the user that credit card 202 inserted into the credit card reader is fully engaged with the credit card reader in the wireless mouse 100. In one embodiment of the present invention, mouse 100 may include a sound emitting circuit that emits a beep or a series of beeps when credit card 202 is fully inserted in addition to the LEDs or in place of the LEDs.

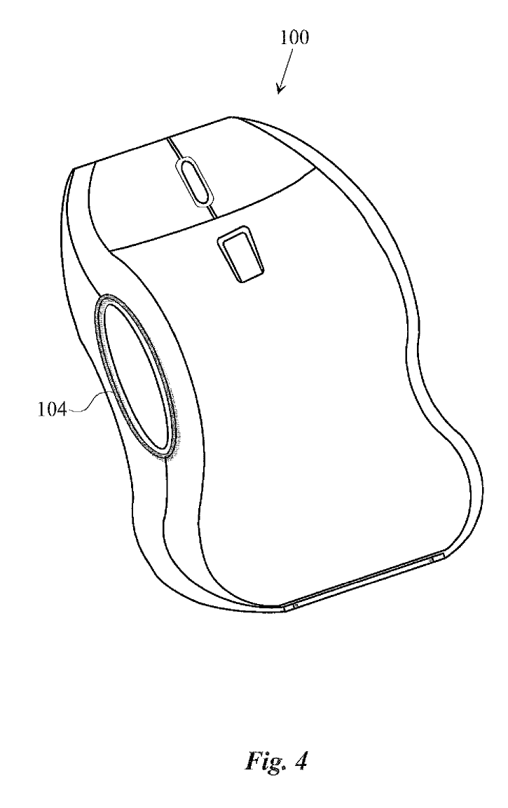

FIG. 4 is a top perspective view computer mouse 100 with of FIG. 1, in which a biometric scanner button is illuminated to indicate completion of the biometric scanning process, according to one embodiment of the present invention. With respect to FIG. 4, wireless mouse 100 is provided with biometric fingerprint scanner button 104 at a side surface so that biometric fingerprint button 104 is pressed to activate a finger print/thumb impression scanning process. When the thumb impression/biometric finger print of the user is read fully, a light provided around the perimeter of biometric finger print button 104 is illuminated to indicate the user that thumb impression or the finger print of the user is scanned successfully.

In one embodiment scanner interface 104 is an optical scanner instead of a finger/thumbprint scanner and may detect an authorization code or password provided on a bar code or some other medium. In another embodiment mouse 100 has a retina-scanning device located on top of the mouse. The inventor chooses a thumbprint/fingerprint scanner because of the uniqueness of those biometrics from person to person. In this case button 104 is conveniently located on the left side of mouse 100 to accommodate a user's thumb in an ergonomic manner. In one embodiment a left-handed version of mouse 100 may be provided wherein the scanner button 104 is on the other side of the mouse. Light emitted from the perimeter of button 104 may be LED light from an LED strategically located behind the button. The architecture of scanner button 104 may very somewhat depending on the nature of the scanner without departing from the spirit and scope of the invention.

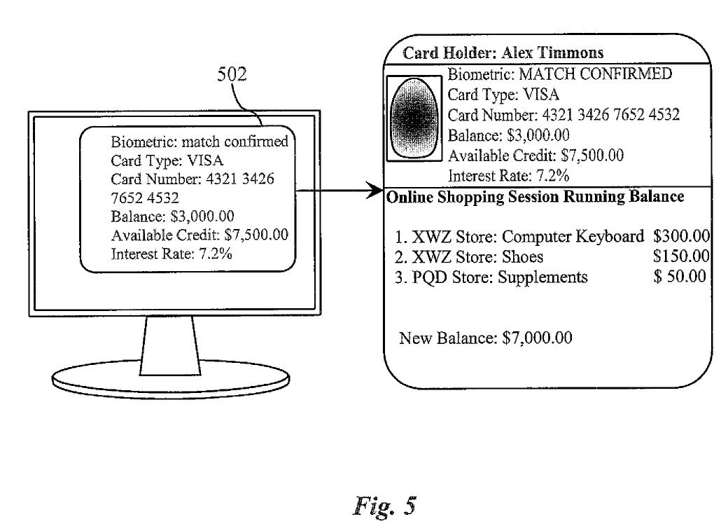

FIG. 5 is a front view of a computer screen and an enlarged view of a graphical user interface displayed as a result of a credit card read and completion of biometric scanning in the wireless biometric computer mouse of FIG. 1, according to one embodiment of the present invention. With respect to FIG. 5, Graphical User Interface (GUI) 502 is displayed on a user's computer screen indicating the successful matching of the biometric fingerprint, after the successful scanning of the user's thumb impression fingerprint.

In one embodiment of the present invention, GUI 502 resides in the onboard memory of the computer mouse and is executed on the computer mouse by virtue of a user scanning in a thumb or fingerprint at which point the GUI is transmitted to a host computer screen and displays on that screen. In another embodiment of the invention GUI 502 resides on the user's computing appliance and is executable on the host system after receiving an execution command from the biometric mouse after a successful scan of the user's biometric.

It is noted herein that a user loads credit card information and validates ownership of the card data by submitting a biometric signature, in this case a thumb or fingerprint. Other users may be added if they share a same credit card. Other users may also be added by the first user (administrator) and may load their credit card data and may submit their own biometric signature. In all cases, GUI 502 causes network navigation on the host computer linking the host computer to an appropriate web site hosted by a credit card company that issued the credit card that the user has loaded or a third-party service organization charged with performing the validation service for numerous financial institutions.

In one embodiment an encrypted Internet connection is used to transmit the user's fingerprint or thumbprint for matching with information stored in a database set up by the credit card company or third-party service organization. When the scanned biometric data and the stored biometric data are same, information is then released and sent back to the user's computer where it is displayed including the credit card data and particulars of the user such as contact information and the like that typically is submitted with the credit card information in an online purchase form.

The credit card information such as, card type, card number, account balance, available credit, and interest rate, etc., is displayed within GUI 502 to enhance the user's online shopping experience, providing up-to-date, real-time information related to the running account balance against the credit card. In order to keep track of the user's purchases, the software shows accurate deductions from the user's balance, whenever a purchase is made and an authorization is granted. Moreover, a user having multiple credit cards loaded into the biometric computer mouse may scan in a biometric signature linked to several cards associated to different issuers and where the validating entity is a third-party service, all of the linked credit card data sets may be returned to GUI 502 so that the user may select which card to use to make the purchase.

The biometric signature and the subsequent matching operations performed by the credit card company or validation service helps to prevent computer hackers from making unauthorized purchases with a user's credit card number, since no purchases will be authorized without the successful biometric matching operations. Likewise identity theft is reduced, as no credit card data is visible without a secure matching of the biometrics of the user against what is on file for the user.

In one embodiment of the present invention GUI 502 includes a data section for listing the user's activity during one or more shopping sessions performed on the network. In one embodiment the information is provided as a result of authorized use of the credit card and the history is a transaction history listing the amounts tendered, the store patronized and the products purchased. In the case of a third-party service performing the authentication of the user, the item purchase histories and available credit balances are obtained from the issuing banks and financial institutions and held for the user by the service.

GUI 502 may be minimized, expanded to full screen display, or displayed as a floating window that can be placed adjacent to or over a browser-based online shopping page being displayed at the same time. In this way, the user has convenient access to all of the credit information and personal information required. In one embodiment while GUI 502 is displayed a user may quickly populate a purchase Web form by first highlighting a data input field in the Web form, then selecting the appropriate data from GUI 502. Object linking and embedding (OLE) protocol enables the data to be pasted into the Web form from the other interface. In a more advanced version of GUI 502 a user may simply select the credit card data set that will be used during a purchasing process and all of the correct information is automatically populated into the appropriate fields of the Web purchase form. In this case, the validation service or financial institution performing the validation process provides the form to the shopping site for clients using the present invention to make purchases.

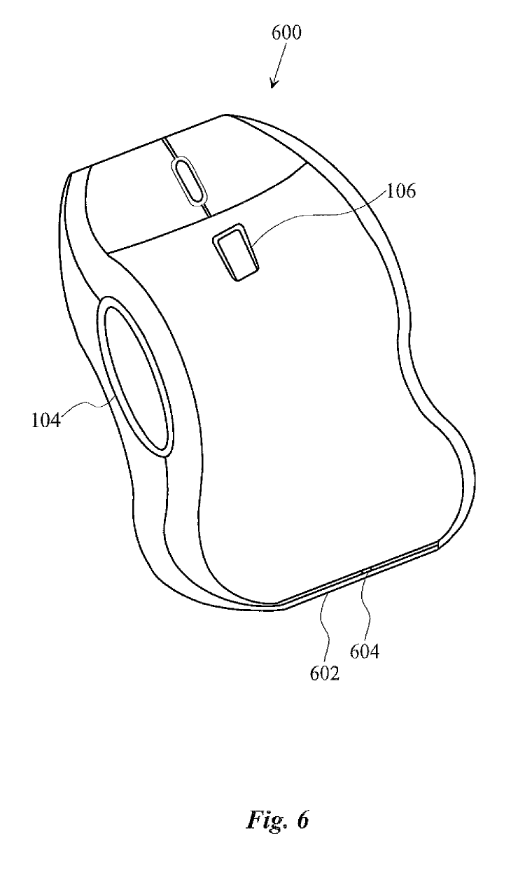

FIG. 6 is a top perspective view of a wireless biometric computer mouse with an integrated card reader having a card swipe interface according to one embodiment of the present invention. A wireless biometric computer mouse 600 is provided with a credit card reader swipe slot 602 at the base of mouse 600 to receive a credit card. In this embodiment a user swipes credit cards through slot 602 for reading the credit cards instead of inserting a card into the credit card reader thereby enabling the user to store information from multiple credit cards at once, digitally in the onboard memory in the mouse.

Each credit card is swiped one-by-one through the credit card reader interface. Mouse 600 is provided with an LED 604 at the upper side of card insertion slot 602 to indicate status of the card reading process. LED 604 will emit red light to indicate to the user that the credit card is not yet read successfully. When the credit card is read successfully, an LED 108 will emit blinking green light. Then the credit card number of the user is loaded into memory and is ready for access whenever the user is engaged in an online shopping session, or to quickly check the credit card balances, and other information relative to any of the preloaded credit cards at any time.

Biometric fingerprint scanner button 104 is provided at a side surface of wireless mouse 600, just as described above for mouse 100, for scanning a user's fingerprint for identification. Quick load button 106 is provided on wireless mouse 600, just as described previously for mouse 100, and for the same purpose as described above, to quickly populate the specific data fields of a Web form used to collect credit card information during the online shopping session.

The user scans and uploads the thumb impression or fingerprint through biometric computer mouse 600 only during the initial software set up process. Multiple users may be defined during the setup process but they are restricted to access their own individual or shared credit card accounts only. Once the set up operation is completed, only the initial user or the users alone can add a new user or delete a user. When the users have loaded all of their desired credit cards and have completed the initial software setup, they can begin using biometric computer mouse 600 with integrated credit card reader function during their online shopping sessions by simply logging in their biometric thumb impression/fingerprint to the software database.

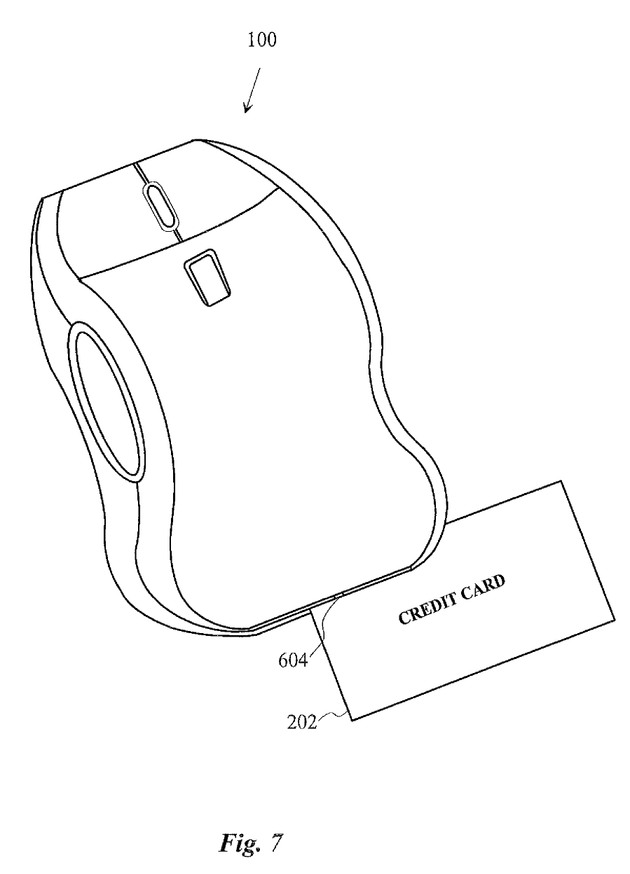

FIG. 7 is a front view of a computer screen and an enlarged view of a graphical user interface after the swiping of multiple credit cards and completion of biometric scanning in the wireless biometric computer mouse of FIG. 6, according to one embodiment of the present invention. In this example, the user has several credit cards that may be validated by the user's thumbprint or fingerprint. The interface analogous to GUI 502 described above and expanded for convenience depicts three credit card data sets.

Each data set is a summary and is interactive so that a user may click on a heading to drill down to more detail. For example, clicking on PDQ bank may reveal the bank's telephone number and mailing address. Selecting any of the other headings in the set may reveal account number, personal information associated with the card, a transaction summary of most recent history, and so on. In one embodiment each of the credit data summaries that appear in interface 502 includes a hyperlink to the Web site of the bank. In this case the user may scan in a thumbprint to bring up the interface and then select a credit card data set to navigate to the Web site of the issuing entity.

In this embodiment as described further above, the user loads multiple cards into the system and the entity performing authentication for the user may be a third-party service providing services to the client and to the issuing institutions. In one embodiment several users may share a single GUI 502, however when the interface is displayed it only shows the relevant information associated with the biometric signature used to launch it.

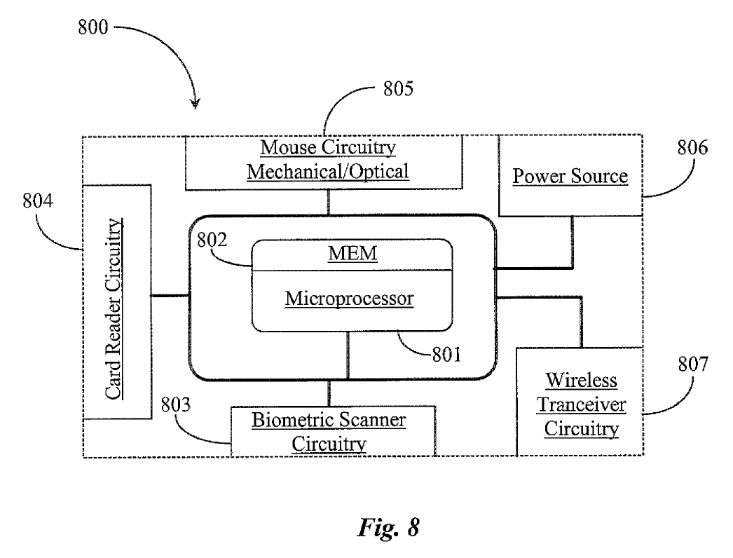

FIG. 8 is a block diagram illustrating basic circuitry components 800 of mouse 100 of FIG. 1 according to an embodiment of the present invention. Components 800 include a microprocessor 801 adapted to perform the processing required for functional operation of the mouse including card reader function and biometric scanner function. A memory (MEM) 802 is provided in this example as an onboard memory for mouse 100. MEM 802 may be a non-volatile memory mixed with a volatile memory, for example a flash-based memory and a random access memory.

A power source 806 is provided to mouse 100 and adapted to provide suitable power for operation in a wireless mode. Power source 806 may be one or more batteries or power cells. Rechargeable power cells may be used. In one embodiment where mouse 100 is a USB device, the mouse may derive power from its host computing appliance. In this example a logical internal bus structure 808 is provided for connecting the components together for interoperation and use of the shared onboard memory 802. Bus structure 8-08 includes data and power line for enabling inter-component communication and power to all components requiring power to operate.

Components 800 include a wireless transceiver circuitry 807 adapted to enable wireless tethering to the host computing appliance. The mouse of the invention may communicate with the host via a wireless protocol such as Bluetooth™, wireless USB, Infrared communication, or some other wireless protocol.

Components 800 include biometric scanner circuitry 803 adapted to enable scan and store of a user's thumb or fingerprint. Card reader circuitry 804 is provided and adapted to enable input and store of credit card data and associated user information. Mouse circuitry 805 is provided to enable normal input function of the mouse. In one embodiment mouse 100 automatically scans a user's thumbprint or fingerprint by default each time the user places is thumb or finger print on the scanner feature of the mouse. In another embodiment a function button is provided on the mouse to enable a user to turn on the scanner and card reader functions of the mouse.

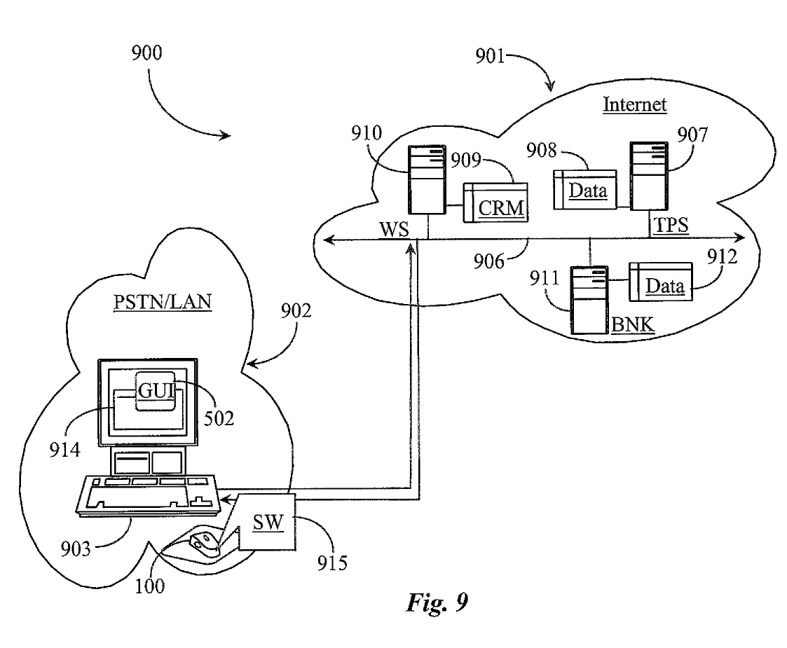

FIG. 9 is an architectural overview of a credit authentication network 900 incorporating mouse 100 of FIG. 1 according to an embodiment of the present invention. Network 900 includes the well-known Internet network 901 and at least one carrier network 902 such as a LAN or a public switched telephone network (PSTN). Internet 901 is further represented in this example by a network backbone 906. Backbone 906 logically represents all of the lines, equipment, and access points that make up the Internet network as a whole; therefore, there are no geographic limitations to the practicing of the present invention.

A host computer 903 is illustrated in this example and represents a computing appliance used by a user practicing the present invention. Computer 903 may be some other type of computing appliance without departing from the spirit and scope of the present invention such as a personal digital assistant (PDA), smart phone, notebook, or any other network capable appliance with a display screen. Mouse 100 is illustrated in this example as an input device to computer 903. Mouse 100 has software (SW) 915 provided thereto and adapted to launch GUI 502 illustrated as displayed on the display screen of computer 903. Also displayed on computer 903 is a shopping interface 914. In this case the user is actively engaged in a shopping session and is practicing the invention.

Computing appliance 903 has connection to Internet 901, more particularly to backbone 906. The Internet access may be provided by a variety of methods including dial-up, cable/modem, broadband wireless, direct TX connection, via a LAN network, and so on. An Internet service provider (ISP) may be assumed present in this embodiment though none is illustrated.

A Web server (WS) 910 is illustrated within network 903 and connected to backbone 906. WS 910 is adapted to serve electronic information pages (Web pages) and hosts one or more shopping pages including shopping interface 914 illustrated in display on computer 903. Computer 903 is then presumed connected to WS 910 on the Internet network. A customer relations data (CRM) database 909 is provided as a digital medium accessible to WS 910. CRM database 909 is adapted to hold customer data, product and service data, transaction data, etc.

In this example a bank (BNK) server 911 is illustrated within network 901 and is connected to backbone 906. BNK server 911 represents any first party server used by any financial institution that may authenticate any user such the one operating computer 903 and connected mouse 100. In this case, server 911 has a data repository 912 connected to it and adapted to store user credit card data and authentication data such as biometric signatures of cardholders of credit cards issued by the bank or financial institution.

In one embodiment a third party server (TPS) 907 is provided within Internet 901 and connected to backbone 906. TPS 907 is adapted to authenticate user biometrics associated with their active credit cards on behalf of multiple first party institutions like banks, for example. TPS 907 has a data repository 908 accessible thereto and adapted similarly to repository 912 connected to BNK server 911. However, TPS stores credit card data and authentication signatures for a wide variety of financial systems. In this case TPS 907 services financial institutions that have issued credit cards to users that are authenticated by biometric signature of the cardholders It is noted herein that there may be more than one cardholder per issued card and therefore, a number of different biometric signatures may be associated with the same credit card data.

To use the present invention, a user may, operating computer 903, connect to Internet 901 and backbone 906 and may log into WS 910 to perform online shopping. When desired, the user may scan a biometric signature such as a thumbprint or fingerprint using the biometric scanner of mouse 100. This action may be performed subsequently to the user inserting a credit card into; or swiping a credit card through the card reader on mouse 100. The credit card data may be previously stored such that once loaded into the card reader it does not have to be read repeatedly such as every time the user desires to purchase something.

In one embodiment the act of scanning in a biometric signature launches SW 915 to generate GUI 502 by default. In this case GUI 502 is generated on mouse 100 and is sent to the screen of computer 903 for display. The transmission of the interface includes the biometric signature last scanned. The biometric signature may be a thumbprint associated with a specific credit card data set. In another embodiment, the GUI resides on computing appliance 903 and may be executed to display on the computer screen via a launch command sent to the host by mouse 100. In this case the biometric signature scanned is forwarded along with the execution command for the GUI.

When GUI 502 displays, it causes the computer navigation system (Browser) to open a network connection to server 911 or to server 907, whichever is performing the authentication of the credit card data. GUI 502 requests an authentication and sends at least the biometric signature of the user and, perhaps one default credit card data set (credit card number). In one embodiment only the biometric signature need be sent. In another embodiment the biometric signature and the last four digits of the user's card are sent. In a preferred embodiment the information is sent over a connection that is encrypted to prevent hackers from intercepting the data and deciphering the information. In one embodiment a secure socket layer (SSL) security protocol is used for the connection between the user and the server.

The validation procedure consists of a database lookup in order to match the user's biometric signature to one on file in a repository accessible to the server. If there is no match, an error message is returned to GUI 502 explaining that authentication failed. In that case the user will not be able to use that credit card data for any purchase. If the server finds a match of the biometric signature sent by GUI 502 to a biometric signature on file, the server retrieves and sends the user's updated credit card information to interface 502 whereupon it may be displayed for the user to see and manipulate. In one embodiment the send of one biometric signature returns credit card data sets for multiple credit cards linked to the signature. In this case all of those cards are automatically authenticated for use in the current session. In one embodiment, after an authenticated card is used to make a purchase, it has to be authenticated again in order to make another purchase at a different shopping interface. In one embodiment an authenticated credit card may be used repeatedly in the same shopping interface such as a checkout page for multiple purchases as long as the user does not quit the online session with the site.

In the case of TPS 907 providing credit card authentication and information return, banking or financial institution that issued the card may provide periodic updates to the user's card accounts such as recent transaction history, available balance, change of address, interest rate changes, current credit limit, and so on. In one embodiment all of this additional information is returned to interface 502 every time an authentication request is received from GUI 502. Other data may also be provided such as all of the user's current contact information, city of residence, country of residence, zip code, and any other data that might be required to initiate and complete an online transaction. In one embodiment the data that displays in GUI 502 is also encrypted so that onlookers cannot read the data in the interface. The user may be provided with a decryption key to decrypt the data for visual dissemination.

It will be apparent to one with skill in the art that the biometric mouse credit card authentication system of the invention may be provided using some or all of the mentioned features and components without departing from the spirit and scope of the present invention. It will also be apparent to the skilled artisan that the embodiments described above are specific examples of a single broader invention, which may have greater scope than any of the singular descriptions taught. There may be many alterations made in the descriptions without departing from the spirit and scope of the present invention.

What is claimed is:

1. A computer mouse comprising:
a digital medium for storing executable software and user data;
a wireless transceiver;
a credit card reader; and,
a biometric scanner;
characterized in that a user operating the mouse connected to a computing appliance may validate stored credit card information as belonging to the user by performing a biometric match of biometrics of the user taken by the biometric scanner against biometrics and profile data stored in a network-based data server, and whereupon a successful match of biometrics invokes a graphics user interface stored on the digital medium to display on a display device accessible to the computing appliance, the interface containing the credit card information belonging to the authenticated user for the one or more cards authenticated.

2. The computer mouse of claim 1 wherein the digital medium is an onboard memory chip.

3. The computer mouse of claim 1 wherein the graphics user interface has network connectivity to the network-based data server via a universal resource locator.

4. The computer mouse of claim 1 wherein the credit card reader has a card insert bay.

5. The computer mouse of claim 1 wherein the credit card reader as a card-swiping slot.

6. The computer mouse of claim 1 further including one or more visual indicators of a successful read by the card reader.

7. The computer mouse of claim 6 further including one or more visual indicators of a successful read of biometrics.

8. The computer mouse of claim 1 wherein the network-based data server is hosted by a credit card company issuing the credit card or cards owned by the user.

9. The computer mouse of claim 1 wherein the network-based data server is hosted by a third-party service organization that services multiple credit card companies and financial institutions.

10. The computer mouse of claim 1 wherein the biometrics scanner scans thumb or finger prints.

11. The computer mouse of claim 1 wherein the biometrics scanner scans the user's eye.

12. The computer mouse of claim 1 wherein the digital medium holds credit card information for multiple users that have authorization to use the mouse as a card reader.

13. A method for authenticating credit card data for use in a network-hosted shopping interface comprising the steps:
(a) reading the credit card data using a credit card reader in communication with a network-connected computing appliance;
(b) scanning a biometric of the credit card owner using a biometrics scanner in communication with the network-connected computing appliance;
(c) transmitting the credit card data and the scanned biometric along with a graphics user interface or a command to execute a graphics user interface to the network-connected computing device;
(d) executing a universal resource locator from the graphics user interface, the universal resource locator addressing an authentication service hosted on a network-connected data server;
(e) sending the credit card data and scanned biometric to the authentication service;
(f) performing a lookup in a data repository via the authentication service to attempt to match the credit card data and biometric to data held in the repository;
(g) upon finding a match, sending all relevant credit card data and information back to the graphics user interface.

14. The method of claim 13 wherein in step (a) the credit card reader is integrated with a computer mouse.

15. The method of claim 14 wherein in step (b) the biometrics scanner is integrated with the computer mouse and credit card reader.

16. The method of claim 15 wherein in step (a) the credit card data is read by inserting a credit card into a card bay of the credit card reader.

17. The method of claim 15 wherein in step (b) the biometric scanner scans a fingerprint or a thumbprint.

18. The method of claim 13 wherein in step (c) the method of transmission is wireless data transfer.

19. The method of claim 13 wherein in step (d) execution of the universal resource locator is automated and occurs as part of executing the graphics user interface.

20. The method of claim 15 wherein in step (g) the information sent back includes additional credit card data validated by the same biometric match.

21. The method of claim 20, further including a step (h) for selecting a credit card data set returned to the graphics user interface in step (g) for use in an online shopping interface displayed on the network-connected computing appliance.

22. The method of claim 21, further including a step (i) for populating a Web form with the credit card data and information selected in step (h).
